(19) United States
(12) Patent Application Publication
(10) Pub. No.: US 2018/0115858 A1
(43) Pub. Date: Apr. 26, 2018

(54) SYSTEMS AND METHODS FOR CONNECTING WIRELESS COMMUNICATION DEVICES

(71) Applicant: QUALCOMM Incorporated, San Diego, CA (US)

(72) Inventor: Bhakthavatsala Raghavendra, San Diego, CA (US)

(21) Appl. No.: 15/331,359

(22) Filed: Oct. 21, 2016

(51) Int. Cl. H04W 4/00; H04W 48/16; H04W 76/02

(52) U.S. Cl. CPC H04W 4/008; H04W 76/023; H04W 48/16

(57) ABSTRACT

A method for connecting to a target device by a Bluetooth device based on a position metric is described. The method includes detecting a reference position metric between the Bluetooth device and the target device during pairing of the Bluetooth device and the target device. The method also includes detecting a current position metric between the Bluetooth device and the target device. The method further includes connecting to the target device based on a comparison of the reference position metric and the current position metric.

### TECHNICAL FIELD

The present disclosure relates generally to wireless communications. More specifically, the present disclosure relates to systems and methods for connecting wireless communication devices.

### BACKGROUND

In the last several decades, the use of wireless communication devices has become common. In particular, advances in electronic technology have reduced the cost of increasingly complex and useful wireless communication devices. Cost reduction and consumer demand have proliferated the use of wireless communication devices such that they are practically ubiquitous in modern society. As the use of wireless communication devices has expanded, so has the demand for new and improved features of wireless communication devices. More specifically, wireless communication devices that perform new functions and/or that perform functions faster, more efficiently or more reliably are often sought after.

Advances in technology have resulted in smaller and more powerful wireless communication devices. For example, there currently exist a variety of wireless communication devices such as portable wireless telephones (e.g., smartphones), personal digital assistants (PDAs), laptop computers, tablet computers and paging devices that are each small, lightweight and can be easily carried by users.

A wireless communication device may make use of one or more wireless communication technologies. For example, a wireless communication device may communicate using Bluetooth technology. A Bluetooth device may communicate with one or more target devices. A user may wish to connect a Bluetooth device to a particular target device and disconnect from other target devices. However, it may be cumbersome to manually switch between various target devices. Benefits may be realized by establishing a connection between a Bluetooth device and a target device based on one or more position metrics.

### SUMMARY

A method for connecting to a target device by a Bluetooth device based on a position metric is described. The method includes detecting a reference position metric between the Bluetooth device and the target device during pairing of the Bluetooth device and the target device. The method also includes detecting a current position metric between the Bluetooth device and the target device. The method further includes connecting to the target device based on a comparison of the reference position metric and the current position metric.

The Bluetooth device may connect to the target device if the current position metric is within a certain threshold of the reference position metric. The method may also include disconnecting from the target device if the current position metric is not within a certain threshold of the reference position metric.

The position metric may be an orientation of the Bluetooth device relative to the target device. The orientation may be measured as a signal angle of arrival (AoA) from the Bluetooth device to the target device.

The method may also include receiving the reference position metric and the current position metric from the target device. Alternatively, the Bluetooth device may measure the reference position metric and the current position metric.

The position metric may be a relative distance between the Bluetooth device and the target device. The Bluetooth device may connect to a first target device upon determining that the first target device is closer than a second target device.

The current position metric may be detected in response to a triggering event. The method may also include attempting, by the Bluetooth device, to connect to a plurality of target devices in response to a triggering event. The Bluetooth device may connect to a given target device with a reference position metric that matches the current position metric of the Bluetooth device.

A Bluetooth device configured to connect to a target device based on a position metric is also described. The Bluetooth device includes a processor, a memory in communication with the processor and instructions stored in the memory. The instructions are executable by the processor to detect a reference position metric between the Bluetooth device and the target device during pairing of the Bluetooth device and the target device. The instructions are also executable to detect a current position metric between the Bluetooth device and the target device. The instructions are further executable to connect to the target device based on a comparison of the reference position metric and the current position metric.

A computer-program product is also described. The computer-program product includes a non-transitory computer-readable medium having instructions thereon. The instructions include code for causing a Bluetooth device to detect a reference position metric between the Bluetooth device and a target device during pairing of the Bluetooth device and the target device. The instructions include code for causing the Bluetooth device to detect a current position metric between the Bluetooth device and the target device. The instructions include code for causing the Bluetooth device to connect to the target device based on a comparison of the reference position metric and the current position metric.

An apparatus is also described. The apparatus includes means for detecting a reference position metric between the apparatus and the target device during pairing of the apparatus and the target device. The apparatus also includes means for detecting a current position metric between the apparatus and the target device. The apparatus further includes means for connecting to the target device based on a comparison of the reference position metric and the current position metric.

A method for connecting to a Bluetooth device by a target device based on a position metric is also described. The method includes detecting a reference position metric between the Bluetooth device and the target device during pairing of the Bluetooth device and the target device. The method also includes detecting a current position metric between the Bluetooth device and the target device. The method further includes connecting to the Bluetooth device based on a comparison of the reference position metric and the current position metric.

The target device may connect to the Bluetooth device if the current position metric is within a certain threshold of the reference position metric. The target device may disconnect from the Bluetooth device if the current position metric is not within a certain threshold of the reference position metric. The target device may measure the reference position metric and the current position metric.

A target device configured to connect to a Bluetooth device based on a position metric is also described. The target device includes a processor, a memory in communication with the processor and instructions stored in the memory. The instructions are executable by the processor to detect a reference position metric between the Bluetooth device and the target device during pairing of the Bluetooth device and the target device. The instructions are also executable to detect a current position metric between the Bluetooth device and the target device. The instructions are further executable to connect to the Bluetooth device based on a comparison of the reference position metric and the current position metric.

A computer-program product is also described. The computer-program product includes a non-transitory computer-readable medium having instructions thereon. The instructions include code for causing a target device to detect a reference position metric between a Bluetooth device and the target device during pairing of the Bluetooth device and the target device. The instructions include code for causing the target device to detect a current position metric between the Bluetooth device and the target device. The instructions include code for causing the target device to connect to the Bluetooth device based on a comparison of the reference position metric and the current position metric.

An apparatus is also described. The apparatus includes means for detecting a reference position metric between a Bluetooth device and the apparatus during pairing of the Bluetooth device and the apparatus. The apparatus also includes means for detecting a current position metric between the Bluetooth device and the apparatus. The apparatus further includes means for connecting to the Bluetooth device based on a comparison of the reference position metric and the current position metric.

### BRIEF DESCRIPTION OF THE DRAWINGS

FIG. 1 is a block diagram illustrating one configuration of wireless communication system in which position-based connections may be implemented;

FIG. 2 is a flow diagram illustrating a configuration of a method for position-based connection to a target device;

FIG. 3 is an example illustrating the use of orientation for position-based connection of a Bluetooth device to a first target device or second target device;

FIG. 4 is an example illustrating the use of relative distance for position-based connection of a Bluetooth device to a first target device or a second target device;

FIG. 5 is a flow diagram illustrating a configuration of a method for connecting to a target device based on an orientation of a Bluetooth device;

FIG. 6 is a flow diagram illustrating another configuration of a method for connecting to a target device based on an orientation of a Bluetooth device;

FIG. 7 is a flow diagram illustrating a configuration of a method for connecting to a first target device or a second target device based on an orientation of a Bluetooth device;

FIG. 8 is a sequence diagram illustrating position-based connection of a Bluetooth device to a first target device or a second target device;

FIG. 9 is an example of orientation-based connection by a remote controller to a television, an air conditioning (AC) unit or a set-top box;

FIG. 10 is a flow diagram illustrating a configuration of a method for connecting to a target device based on a relative distance; and

FIG. 11 illustrates certain components that may be included within a wireless communication device.

### DETAILED DESCRIPTION

Current Bluetooth technology provides for establishing a connection between a Bluetooth device and one or more target devices. A Bluetooth device may be paired to multiple devices. Therefore, the Bluetooth device may connect to two or more target devices.

A user may wish to connect the Bluetooth device to a particular target device. For example, the Bluetooth device may be a human interface device protocol (HID) device. In one scenario, the Bluetooth device may be a keyboard, mouse or other input device and the target devices may be different personal desktop computers. The user may wish to connect the Bluetooth device to a particular computer and disconnect from other computers.

In another scenario, the Bluetooth device may be a remote controller configured to connect to multiple target devices (e.g., television, air conditioning (AC) unit, set-top box, etc.). Instead of having multiple remote controllers (e.g., one remote controller for each target device), the user may wish to connect to a particular target device using a single remote controller.

The described systems and methods provide for establishing a connection to a target device based on position metrics. In one implementation, the position metric may be the orientation of the Bluetooth device relative to the target device. In another implementation, the position metric may be the relative distance between the Bluetooth device and the target device.

A reference position metric may be recorded when the Bluetooth device pairs with a target device. Then, the Bluetooth device may connect to or disconnect from a target device based on a comparison of a current position metric with the reference position metric.

Various configurations are now described with reference to the Figures, where like reference numbers may indicate functionally similar elements. The systems and methods as generally described and illustrated in the Figures herein could be arranged and designed in a wide variety of different configurations. Thus, the following more detailed description of several configurations, as represented in the Figures, is not intended to limit scope, as claimed, but is merely representative of the systems and methods.

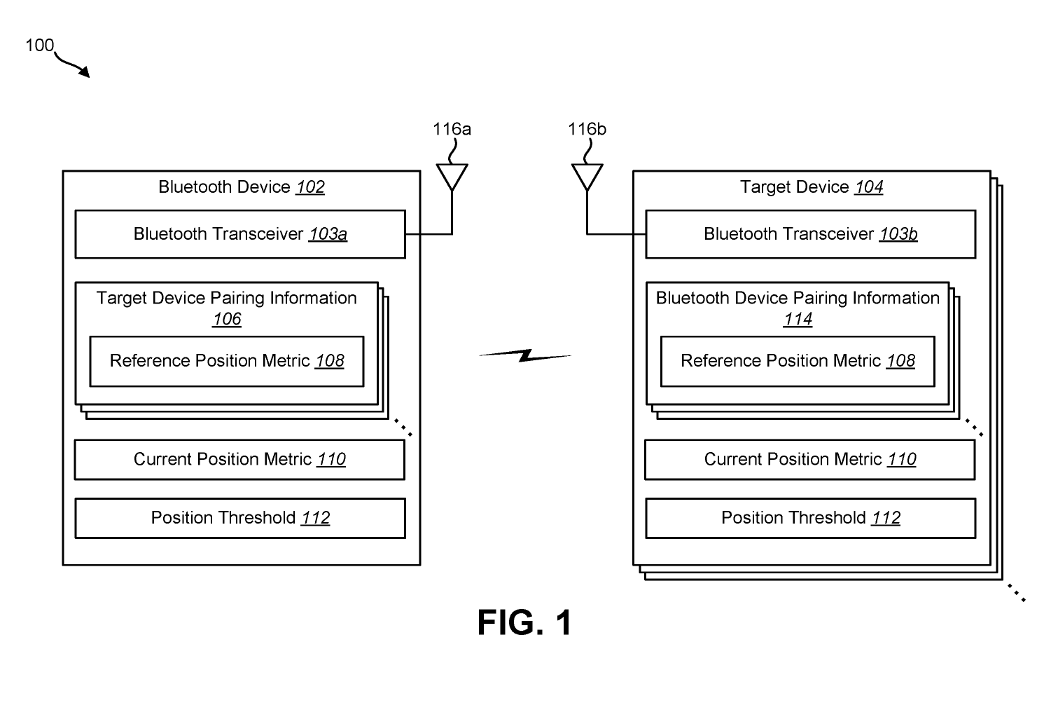

FIG. 1 is a block diagram illustrating one configuration of wireless communication system 100 in which position-based connections may be implemented. The wireless communication system 100 may include a Bluetooth device 102 and one or more target devices 104. Wireless communication systems 100 are widely deployed to provide various types of communication content such as voice, data, and so on.

Some wireless communication devices may utilize multiple communication technologies. For example, one communication technology may be utilized for mobile wireless system (MWS) (e.g., cellular) communications, while another communication technology may be utilized for wireless connectivity (WCN) communications. MWS may refer to larger wireless networks (e.g., wireless wide area networks (WWANs), cellular phone networks, Long Term Evolution (LTE) networks, Global System for Mobile Communications (GSM) networks, code division multiple access (CDMA) networks, CDMA2000 networks, wideband CDMA (W-CDMA) networks, Universal mobile Telecommunications System (UMTS) networks, Worldwide Interoperability for Microwave Access (WiMAX) networks, etc.). WCN may refer to relatively smaller wireless networks (e.g., wireless local area networks (WLANs), wireless personal area networks (WPANs), IEEE 802.11 (Wi-Fi) networks, Bluetooth (BT) networks, wireless Universal Serial Bus (USB) networks, etc.).

Communications in a wireless communication system 100 (e.g., a multiple-access system) may be achieved through transmissions over a wireless link. Such a wireless link may be established via a single-input and single-output (SISO), multiple-input and single-output (MISO) or a multiple-input and multiple-output (MIMO) system. A MIMO system includes transmitter(s) and receiver(s) equipped, respectively, with multiple (N_{T}) transmit antennas and multiple (N_{R}) receive antennas for data transmission. SISO and MISO systems are particular instances of a MIMO system. The MIMO system can provide improved performance (e.g., higher throughput, greater capacity or improved reliability) if the additional dimensionalities created by the multiple transmit and receive antennas are utilized.

A Bluetooth device 102 is an electrical device that is configured to communicate using Bluetooth protocols. A Bluetooth device 102 may also be referred to as a wireless communication device, a wireless device, a mobile device, mobile station, subscriber station, client, client station, user equipment (UE), remote station, access terminal, mobile terminal, terminal, user terminal, subscriber unit, etc. Examples of Bluetooth devices 102 include laptop or desktop computers, cellular phones, smartphones, wireless modems, e-readers, tablet devices, gaming systems, keyboards, keypads, computer mice, remote controllers, headsets, etc.

The Bluetooth device 102 may include a Bluetooth transceiver 103a that is configured to establish links with one or more target devices 104 that have a Bluetooth transceiver 103b. The Bluetooth device 102 may include one or more antennas 116a. The target device 104 may also include one or more antennas 116b.

Bluetooth is a packet-based protocol with a master-slave structure. Bluetooth operates in the Industrial, Scientific and Medical (ISM) 2.4 GHz short-range radio frequency band (e.g., 2400-2483.5 MHz). Bluetooth uses a radio technology called frequency-hopping spread spectrum in which transmitted data is divided into packets and each packet is transmitted on a designated Bluetooth frequency (e.g., channel 118).

Communications in a Bluetooth network may be achieved based on a master polled system. The master polled system may utilize time-division duplexing (TDD) in which a Bluetooth device 102 may send a packet to a target device 104. For example, the Bluetooth device 102 may send a packet to the target device 104 during pairing or during a connection request. In one implementation, the Bluetooth device 102 may be a master device and the target device 104 may be a slave device. In a master polled system, the Bluetooth device 102 sending the packet gives the slave wireless device the ability to transmit back.

The Bluetooth wireless communication standard is typically employed for exchanging communications between fixed or mobile Bluetooth-enabled devices over short distances. In some configurations, the systems and methods disclosed herein may be applied to Bluetooth Low Energy (BLE) devices. LE refers to the “Low Energy” extension of the Bluetooth standard. The BLE extension is focused on energy-constrained applications such as battery-operated devices, sensor applications, etc. The BLE extension may also be referred to as Bluetooth Smart.

The following description uses terminology associated with the Bluetooth and Bluetooth LE standards. Nevertheless, the concepts may be applicable to other technologies and standards that involve modulating and transmitting digital data. Accordingly, while some of the description is provided in terms of Bluetooth standards, the systems and methods disclosed herein may be implemented more generally in wireless communication devices that may not conform to Bluetooth standards.

In an implementation, the Bluetooth device 102 may be configured to operate according to a Bluetooth human interface device (HID) profile. An HID device is a type of hardware that directly interacts with and receives input from a human. Examples of HID devices include keyboards, keypads, joysticks, gaming console controllers, remote controllers, computing mice, etc. The Bluetooth HID profile enables an HID device to wirelessly connect to target devices 104 (e.g., PC, tablet, phones) and interact with the target device 104 over Bluetooth. An HID device configured to communicate using Bluetooth may be referred to as a Bluetooth HID device.

Bluetooth HID has been enabled over BLE, which is more power efficient than the classic Bluetooth Basic Rate/Enhanced Data Rate (BR/EDR). HID over Bluetooth Low Energy may be referred to as a HID over Generic Attribute (GATT) profile (HoGP).

In some environments, a Bluetooth device 102 (e.g., a Bluetooth HID device) may be paired with multiple target devices 104. For example, a Bluetooth keyboard may be paired with multiple personal computing devices (e.g., PC, tablet, smartphone).

A user may want to use the Bluetooth device 102 with different target devices 104 at different times, and when needed. For example, in the case of professional desktops, it is very common for a user to have more than one computer. The user may wish to operate these computers using the same Bluetooth device 102.

One approach to using a single Bluetooth device 102 with multiple target devices 104 is to manually switch the Bluetooth device 102 between the target devices 104. However, it is very cumbersome to switch between various target devices 104 as the Bluetooth device 102 needs to disconnect from one target device 104 and connect to another target device 104.

Another typical environment is a home or business in which multiple remote controllers control various target devices 104. For example, a home may have a television, an AC unit and a set-top box that may each have a separate remote controller. In this scenario, it may be very cumbersome for a user to remember or keep track of the various remote controllers for these target devices 104.

According to the described systems and methods, the Bluetooth device 102 and one or more target devices 104 may perform position-based connection and disconnection. A Bluetooth device 102, a target device 104 or both may include a mechanism to detect a position metric. The Bluetooth device 102 may automatically connect to a desired target device 104 when the position metric meets certain criteria. Similarly, the Bluetooth device 102 may disconnect from a target device 104 when the position metric fails to meet the certain criteria.

In one approach, the position metric may be an orientation of the Bluetooth device 102 relative to the target device 104. A Bluetooth device 102, in particular Bluetooth HID devices, generally point towards the target device 104 with which that Bluetooth device 102 is supposed to connect. For example, a user may point a keyboard or computer mouse toward the desktop computer or monitor that the user would like to use.

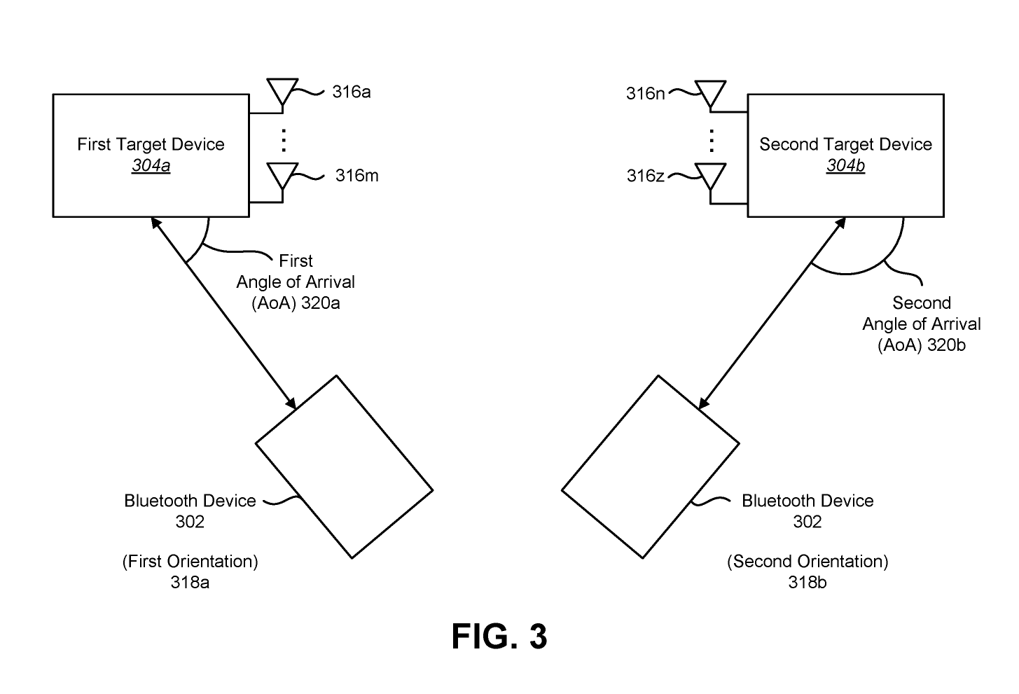

In this approach, the orientation may be measured as a signal angle of arrival (AoA) from the Bluetooth device 102 to the target device 104. For example, the target device 104 may measure the AoA of the signal received from the Bluetooth device 102. Bluetooth Low Energy uses an AoA method to obtain in-phase (I) and quadrature (Q) samples for the indoor positioning. Alternatively, the orientation may be measured as the angle of departure (AoD) of the signal from Bluetooth device 102. An example in which the orientation of the Bluetooth device 102 is used for position-based connection to the target device 104 is described in connection with FIG. 3.

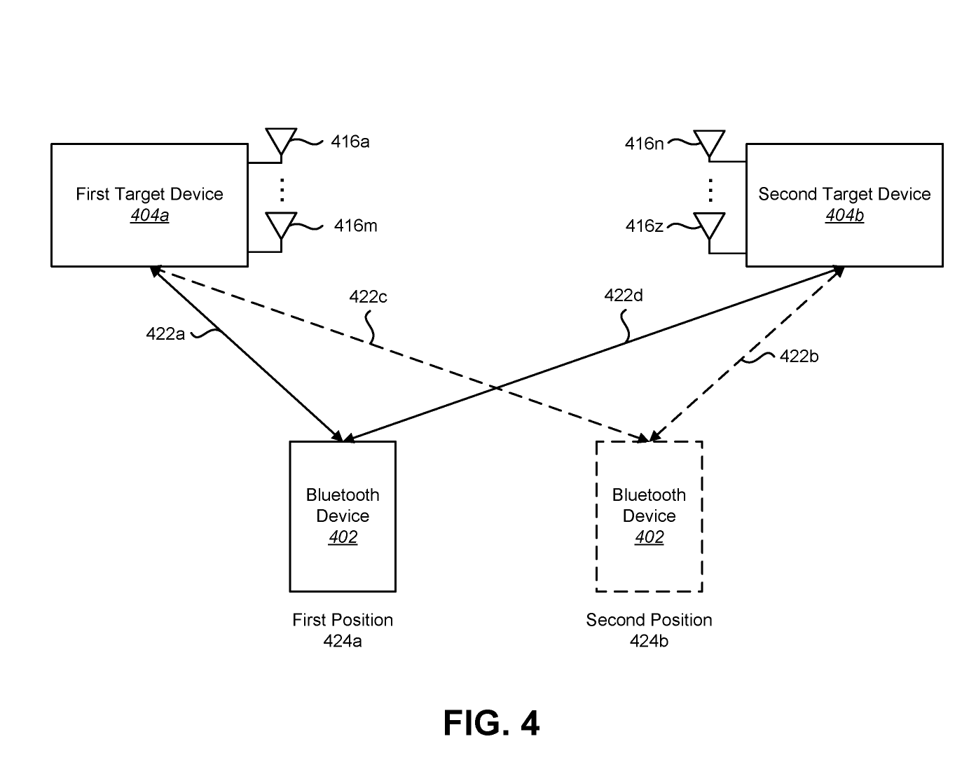

In another approach, the position metric may be a relative distance between the Bluetooth device 102 and the target device 104. For example, the Bluetooth device 102, target device 104 or both may measure the received signal strength indicator (RSSI) of a received signal and may determine a relative distance between the Bluetooth device 102 and the target device 104 using the RSSI. An example in which the relative distance between the Bluetooth device 102 and the target device 104 is used for position-based connection is described in connection with FIG. 4.

The Bluetooth device 102, target device 104 or both may detect a reference position metric 108 during pairing of the Bluetooth device 102 and the target device 104. In one approach, the Bluetooth device 102 may record the reference position metric 108 in target device pairing information 106 associated with a given target device 104. The Bluetooth device 102 may maintain different target device pairing information 106 for each target device 104 with which the Bluetooth device 102 pairs.

In another approach, the target device 104 may record the reference position metric 108 in Bluetooth device pairing information 114 associated with a given Bluetooth device 102. The target device 104 may maintain different Bluetooth device pairing information 114 for each Bluetooth device 102 with which the target device 104 pairs.

In an implementation, the Bluetooth device 102 may receive the reference position metric 108 from the target device 104. For example, the target device 104 may have a plurality of antennas 116b with which the target device 104 determines the reference position metric 108 (e.g., orientation). Upon determining the reference position metric 108, the target device 104 may send the reference position metric 108 to the Bluetooth device 102. For example, the target device 104 may send the reference position metric 108 in a pairing response packet. The Bluetooth device 102 may store the received reference position metric 108 in the target device pairing information 106.

In another implementation, the Bluetooth device 102 may be configured to determine the reference position metric 108 itself. For example, the Bluetooth device 102 may measure the AoA or AoD of a signal sent to the target device 104 to determine the orientation of the Bluetooth device 102 relative to the target device 104. The Bluetooth device 102 may send a signal (e.g., a pairing request) to the target device 104 and may receive a response. The Bluetooth device 102 may measure the reference position metric 108 based on these signals.

In yet another implementation, only the target device 104 records the reference position metric 108. For example, during pairing, the target device 104 may measure and record the reference position metric 108. However, in this implementation, the target device 104 may not communicate the reference position metric 108 back to the Bluetooth device 102.

The Bluetooth device 102, target device 104 or both may detect a current position metric 110. The current position metric 110 may reflect the current orientation or relative distance of the Bluetooth device 102 in relation to the target device 104. For example, a user may move the Bluetooth device 102 at some time after pairing with the target device 104. In this case, the current position metric 110 may reflect a new orientation or relative distance. Alternatively, the Bluetooth device 102 may be in the same position as when it was paired with the target device 104. In this case, the current position metric 110 may be the same as the reference position metric 108.

The current position metric 110 may be detected in response to a triggering event. In an implementation, the triggering event may be a keypress or click on the Bluetooth device 102. For example, a triggering event may occur when a user presses a key on a keyboard. In another implementation, the triggering event may be the expiration of a timer.

In an implementation, the Bluetooth device 102 may receive the current position metric 110 from the target device 104. For example, the triggering event may cause the Bluetooth device 102 to initiate a connection request with the target device 104. Upon receiving the connection request, the target device 104 may detect the current position metric 110. The target device 104 may send the current position metric 110 to the Bluetooth device 102.

In another implementation, the Bluetooth device 102 measures the current position metric 110 itself. For example, the Bluetooth device 102 may send a signal (e.g., a connection request) to the target device 104 and may receive a response. The Bluetooth device 102 may measure the current position metric 110 based on these signals.

In yet another implementation, only the target device 104 detects the current position metric 110. For example, upon receiving a connection request, the target device 104 may measure current position metric 110. However, in this implementation, the target device 104 may not communicate the current position metric 110 back to the Bluetooth device 102.

The Bluetooth device 102, target device 104 or both may determine whether to connect based on a comparison of the reference position metric 108 and the current position metric 110. The Bluetooth device 102 may connect to the target device 104 if the current position metric 110 is within a certain threshold 112 of the reference position metric 108. In an implementation, the Bluetooth device 102, target device 104 or both may be configured with a position threshold 112. The position threshold 112 may be an allowable range for the current position metric 110 relative to the reference position metric 108.

The position threshold 112 may allow for some variation in the orientation or distance of the Bluetooth device 102 relative to the target device 104. The position threshold 112 may be preconfigured or may be user-configurable.

If the difference between the reference position metric 108 and the current position metric 110 is within (e.g., less than or equal to) the position threshold 112, then the reference position metric 108 and the current position metric 110 are considered to match. In this case, the Bluetooth device 102 and the target device 104 may establish a connection if they are not currently connected. If the Bluetooth device 102 and the target device 104 are currently connected, they may remain connected.

If the difference between the reference position metric 108 and the current position metric 110 is not within (e.g., greater than) the position threshold 112, then the reference position metric 108 and the current position metric 110 are considered not to match. In this case, the Bluetooth device 102 and the target device 104 may not establish a connection if they are not currently connected. If the Bluetooth device 102 and the target device 104 are currently connected, they may disconnect.

In an implementation, the Bluetooth device 102 may be paired with multiple target devices 104. For example, the Bluetooth device 102 may be a keyboard that is paired with two desktop computers. A reference position metric 108 may be detected and stored for each of the target devices 104 during pairing. The Bluetooth device 102 may attempt to connect to one of the multiple target devices 104 in response to a triggering event.

The Bluetooth device 102 may connect to a given target device 104 with a reference position metric 108 that matches the current position metric 110 of the Bluetooth device 102. For example, the Bluetooth device 102 may attempt to connect to a first target device 104. The Bluetooth device 102 or first target device 104 may detect a current position metric 110 with respect to the first target device 104. If the current position metric 110 matches the reference position metric 108 of the first target device 104, then the Bluetooth device 102 may connect to the first target device 104. Otherwise, the Bluetooth device 102 may disconnect from the first target device 104. If the Bluetooth device 102 does not connect to the first target device 104, then this process may be repeated with a second target device 104, and so forth, until the Bluetooth device 102 finds a target device 104 with a reference position metric 108 that matches the current position metric 110.

As can be observed by this example, automatic connection and disconnection may be implemented between the Bluetooth device 102 and multiple target devices 104. Once the Bluetooth device 102 and target devices 104 are paired, a user may change the Bluetooth device 102 orientation or location as needed. Upon performing a triggering event (e.g., a click/keypress operation), the Bluetooth device 102 may connect to a new target device 104 automatically and disconnect from the first target device 104.

The described systems and methods may provide an improved user experience. For example, a user may easily connect to or disconnect from one or more target devices 104. This may allow a user to use fewer devices (e.g., a single Bluetooth device 102) to control a plurality of target devices 104. The described systems and methods provide no power penalty while providing improved functionality.

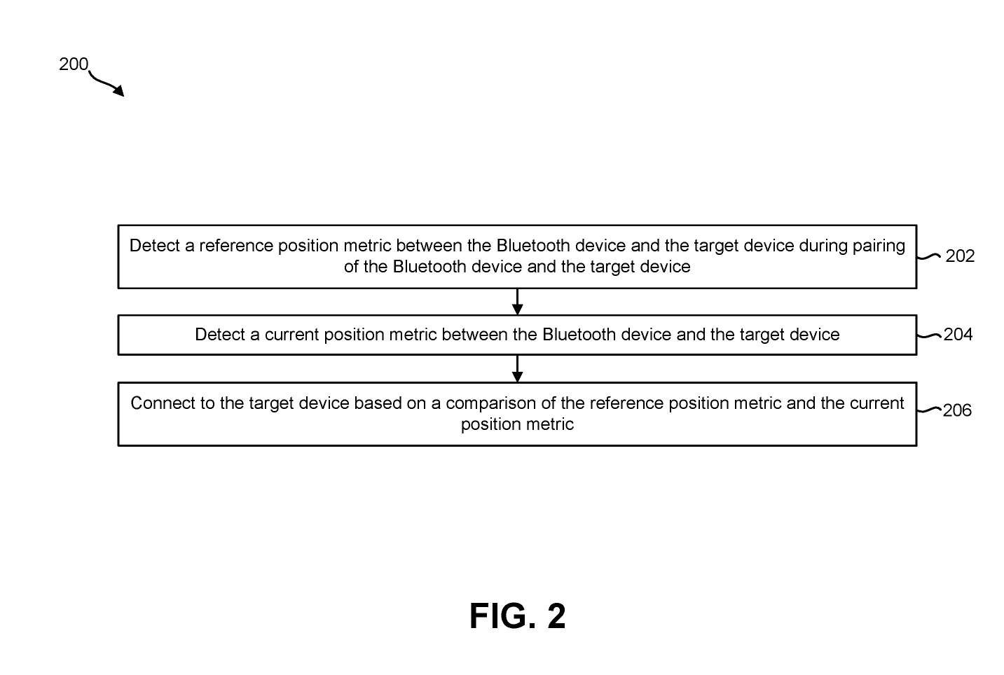

FIG. 2 is a flow diagram illustrating a configuration of a method 200 for position-based connection to a target device 104. This method 200 may be implemented by the Bluetooth device 102. The Bluetooth device 102 may pair with a target device 104. During the pairing, the Bluetooth device 102 and the target device 104 may exchange signals.

The Bluetooth device 102 may detect 202 a reference position metric 108 between the Bluetooth device 102 and the target device 104 during pairing. In one implementation, the reference position metric 108 is an orientation of the Bluetooth device 102 relative to the target device 104. The orientation may be measured as a signal angle of arrival (AoA) from the Bluetooth device 102 to the target device 104. In another implementation, the reference position metric 108 is a relative distance between the Bluetooth device 102 and the target device 104.

The Bluetooth device 102 may detect 204 a current position metric 110 between the Bluetooth device 102 and the target device 104. The current position metric 110 may be detected in response to a triggering event. For example, a triggering event may include a key press on the Bluetooth device 102.

In an approach, the Bluetooth device 102 may receive the reference position metric 108 and the current position metric 110 from the target device 104. For example, the target device 104 may measure the reference position metric 108 or the current position metric 110. The target device 104 may send the reference position metric 108 or the current position metric 110 to the Bluetooth device 102 in a message (e.g., pairing message or connection response message). In another approach, the Bluetooth device 102 may measure the reference position metric 108 and the current position metric 110 itself.

The Bluetooth device 102 may connect 206 to the target device 104 based on a comparison of the reference position metric 108 and the current position metric 110. The Bluetooth device 102 may connect 206 to the target device 104 if the current position metric 110 is within a certain threshold 112 of the reference position metric 108. The Bluetooth device 102 may disconnect from the target device 104 if the current position metric 110 is not within a certain threshold 112 of the reference position metric 108.

In an example where the position metric is the orientation of the Bluetooth device 102, if the difference between the current AoA and the reference AoA is within a threshold 112, then the Bluetooth device 102 may connect to the target device 104. In an example where the position metric is the relative distance between the Bluetooth device 102 and the target device 104, if the difference between the current distance and the reference distance is within a threshold 112, then the Bluetooth device 102 may connect to the target device 104.

FIG. 3 is an example illustrating the use of orientation 318 for position-based connection of a Bluetooth device 302 to a first target device 304a or second target device 304b. The Bluetooth device 302 may be implemented in accordance with the Bluetooth device 102 described in connection with FIG. 1. The target devices 304a-b may be implemented in accordance with the target device 104 described in connection with FIG. 1.

The Bluetooth device 302 may be positioned with a first orientation 318a relative to the first target device 304a. The first orientation 318a may be characterized by a first angle of arrival (AoA) 320a. During pairing, the Bluetooth device 302, first target device 304a or both may perform an AoA estimation to detect the first AoA 320a. For example, the first target device 304a may be configured with a plurality of antennas 316a-m with which the first target device 304a may determine the first AoA 320a of a signal received from the Bluetooth device 302.

The Bluetooth device 302, the first target device 304a or both may save the first AoA 320a that is determined during pairing as a reference position metric 108 (also referred to as a reference orientation). This reference position metric 108 may be saved for future use.

With regard to the second target device 304b, the Bluetooth device 302 may be positioned with a second orientation 318b relative to the second target device 304b. It should be noted that the second orientation 318b of the Bluetooth device 302 is different than the first orientation 318a.

The second orientation 318b may be characterized by a second angle of arrival (AoA) 320b. During pairing, the Bluetooth device 302, the second target device 304b or both may perform an AoA estimation to detect the second AoA 320b. For example, the second target device 304b may be configured with a plurality of antennas 316n-z with which the second target device 304b may determine the second AoA 320b of a signal received from the Bluetooth device 302.

The Bluetooth device 302, the second target device 304b or both may save the second AoA 320b that is determined during pairing as a reference position metric 108 (also referred to as a reference orientation). This reference position metric 108 may be saved for future use.

After pairing with the first target device 304a and the second target device 304b, the Bluetooth device 302 may switch between the target devices 304a-b based on its orientation 318. In an example of a switching sequence, the Bluetooth device 302 may detect a triggering event while in the first orientation 318a. For example, a user may press a key on the Bluetooth device 302.

In this example, if the Bluetooth device 302 attempts to connect to the first target device 304a, the current orientation of the Bluetooth device 302 matches the reference orientation detected during pairing with the first target device 304a. Therefore, the first target device 304a may allow the Bluetooth device 302 to connect. If the Bluetooth device 302 was previously connected to the second target device 304b, then the Bluetooth device 302 disconnects from the second target device 304b. A similar procedure may be implemented to connect to the second target device 304b when the Bluetooth device 302 is positioned in the second orientation 318b.

As observed in this discussion, a user may switch between target devices 304 simply by changing the orientation 318 of the Bluetooth device 302 and initiating a triggering event. The Bluetooth device 302 then automatically connects to the target device 304 corresponding to the current orientation 318 and disconnects from other target devices 304 that do not match the current orientation 318.

The Bluetooth device 302 may try to connect to the target devices 304a-b one-by-one in sequence. In an implementation, the Bluetooth device 302 may attempt to connect to all paired target devices 304 within range. For example, if the Bluetooth device 302 does not connect to the first target device 304a, then the Bluetooth device 302 may attempt to connect to the second target device 304b. In this approach, a target device 304 will allow connection by matching the orientation 318 using the AoA method.

It should be noted that other methods of determining the orientation 318 may be used. For example, the angle of departure (AoD) of the signal from the Bluetooth device 302 may be used instead of or in addition to the AoA.

FIG. 4 is an example illustrating the use of relative distance 422 for position-based connection of a Bluetooth device 402 to a first target device 404a or a second target device 404b. The Bluetooth device 402 may be implemented in accordance with the Bluetooth device 102 described in connection with FIG. 1. The target devices 404a-b may be implemented in accordance with the target device 104 described in connection with FIG. 1.

The Bluetooth device 402 may be located at a first position 424a (i.e., location) relative to the first target device 404a. The first position 424a may be characterized by a first relative distance 422a between the Bluetooth device 402 and the first target device 404a. During pairing, the Bluetooth device 402, first target device 404a or both may perform a distance estimation to detect the first relative distance 422a. For example, the first target device 404a may be configured with a plurality of antennas 416a-m with which the first target device 404a may determine the first relative distance 422a based on the signal received from the Bluetooth device 402. In an implementation, I and Q samples may be used to determine the position of the device using location algorithms.

The first target device 404a may save the first relative distance 422a that is determined during pairing as a reference position metric 108 (also referred to as a reference distance). This reference position metric 108 may be saved for future use.

With regard to the second target device 404b, the Bluetooth device 402 may be located at a second position 424b relative to the second target device 404b. It should be noted that the second position 424b of the Bluetooth device 402 is different than the first position 424a.

The second position 424b may be characterized by a second relative distance 422b between the Bluetooth device 402 and the first target device 404a. During pairing, the Bluetooth device 402, second target device 404b or both may perform a distance estimation to detect the second relative distance 422b. For example, the second target device 404b may be configured with a plurality of antennas 416n-z with which the second target device 404b may determine the second relative distance 422b based on the signal received from the Bluetooth device 402.

The second target device 404b may save the second relative distance 422b that is determined during pairing as a reference position metric 108 (also referred to as a reference distance). This reference position metric 108 may be saved for future use.

It should be noted that when the Bluetooth device 402 is in the first position 424a, the relative distance 422a to the first target device 404a is different than the relative distance 422c when the Bluetooth device 402 is in the second position 424b. Similarly, when the Bluetooth device 402 is in the first position 424a, the relative distance 422d to the second target device 404b is different than the relative distance 422b when the Bluetooth device 402 is in the second position 424b.

After pairing with the first target device 404a and the second target device 404b, the Bluetooth device 402 may switch between the target devices 404a-b based on its position 424. In an example of a switching sequence, the Bluetooth device 402 may detect a triggering event while in the first position 424a. For example, a user may press a key on the Bluetooth device 402.

In this example, if the Bluetooth device 402 attempts to connect to the first target device 404a, the current distance 422a to the first target device 404a at the first position 424a matches the reference distance detected during pairing with the first target device 404a. Therefore, the first target device 404a may allow the Bluetooth device 402 to connect. If the Bluetooth device 402 was previously connected to the second target device 404b, then the Bluetooth device 402 disconnects from the second target device 404b. It should be noted that the current distance 422d to the second target device 404b does not match the reference distance 422b detected during pairing with the second target device 404b. Therefore, the Bluetooth device 402 does not connect to the second target device 404b.

As observed in this discussion, a user may switch between target devices 404 simply by changing the position 424 of the Bluetooth device 402 and initiating a triggering event. The Bluetooth device 402 then automatically connects to the target device 404 with a relative distance 422 corresponding to the current position 424 and disconnects from other target devices that do not match the relative distance 422 at the current position 424.

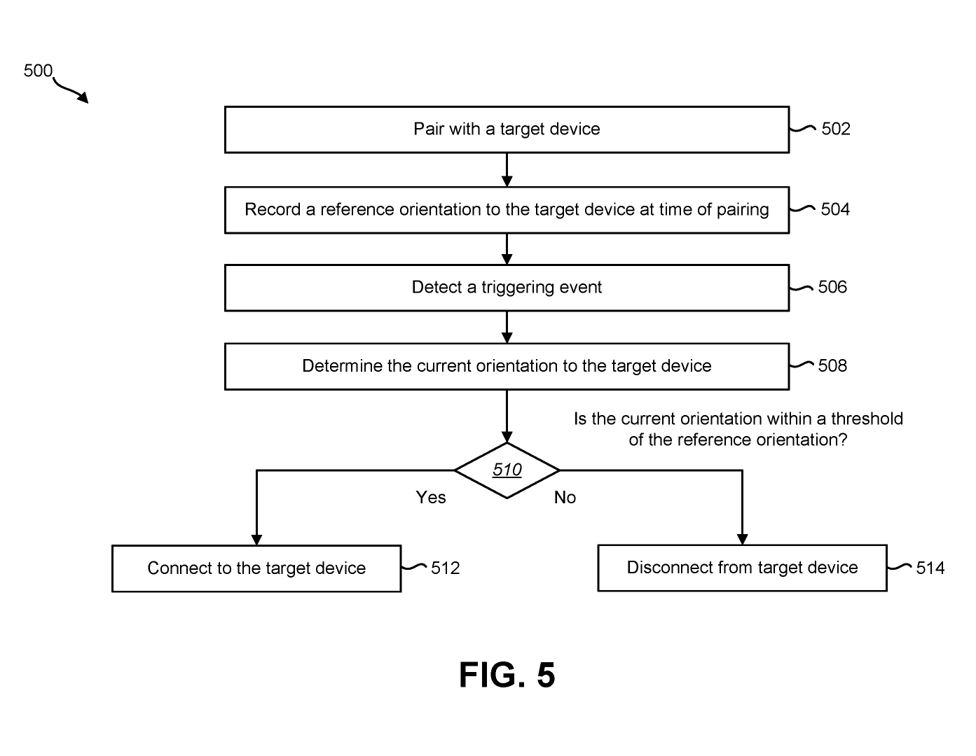

FIG. 5 is a flow diagram illustrating a configuration of a method 500 for connecting to a target device 104 based on an orientation 318 of a Bluetooth device 102. This method 500 may be implemented by the Bluetooth device 102.

The Bluetooth device 102 may pair 502 with a target device 104. During the pairing, the Bluetooth device 102 and the target device 104 may exchange signals.

The Bluetooth device 102 may record 504 a reference orientation 318 to the target device 104 at the time of pairing. The orientation 318 of the Bluetooth device 102 may be measured as a signal angle of arrival (AoA) from the Bluetooth device 102 to the target device 104.

In one implementation, the Bluetooth device 102 may receive the reference orientation 318 from the target device 104, which measures the reference orientation 318. In another implementation, the Bluetooth device 102 may measure the reference orientation 318 itself.

The Bluetooth device 102 may detect 506 a triggering event. For example, the Bluetooth device 102 may detect 506 that a key was pressed on the Bluetooth device 102.

The Bluetooth device 102 may determine 508 the current orientation 318 to the target device 104. As with the reference orientation 318, the Bluetooth device 102 may receive the current orientation 318 from the target device 104 or the Bluetooth device 102 may measure the current orientation 318 itself.

If the orientation 318 of the Bluetooth device 102 has changed since pairing with the target device 104, then the current orientation 318 will be different than the reference orientation 318. If the orientation 318 of the Bluetooth device 102 has not changed since pairing with the target device 104, then the current orientation 318 will be the same as the reference orientation 318.

The Bluetooth device 102 may determine 510 whether the current orientation 318 is within a threshold 112 of the reference orientation 318. In an implementation, the Bluetooth device 102 may determine 510 whether the difference between the current AoA and the reference AoA is within the threshold 112.

If the current orientation 318 is within a threshold 112 of the reference orientation 318, then the current orientation 318 is considered to match the reference orientation 318 and the Bluetooth device 102 may connect 512 to the target device 104 (or remain connected if currently connected to the target device 104). However, if the Bluetooth device 102 determines 510 that the current orientation 318 is not within a threshold 112 of the reference orientation 318, then the Bluetooth device 102 may disconnect 514 from the target device 104 (or remain disconnected if not currently connected to the target device 104).

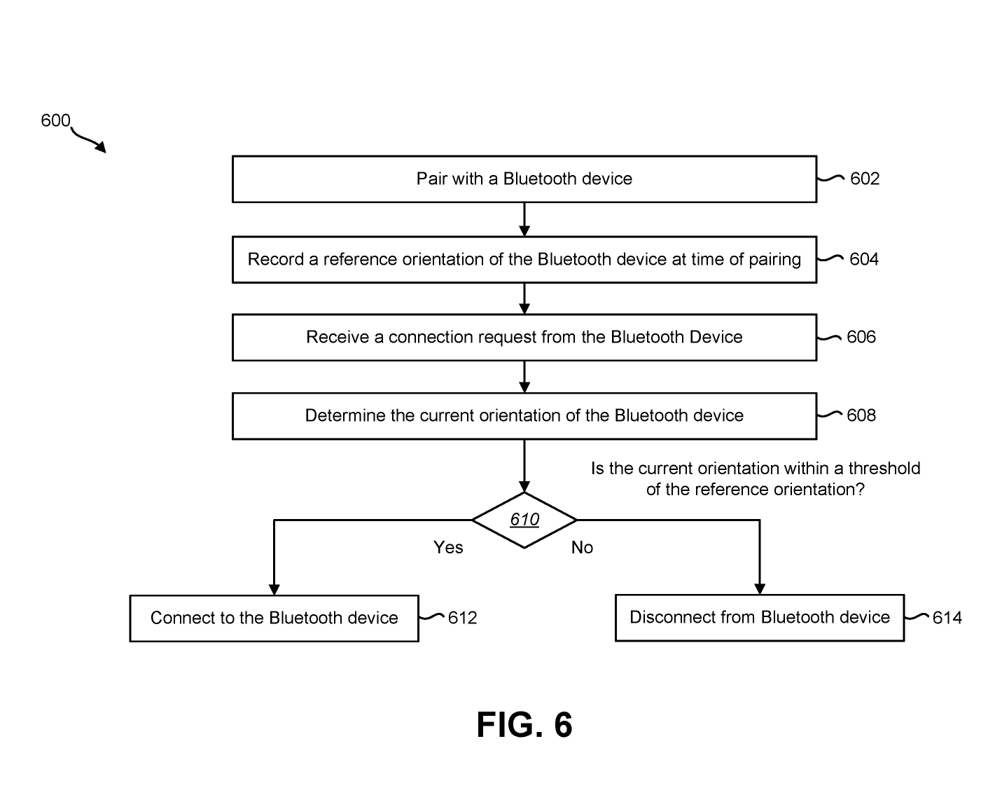

FIG. 6 is a flow diagram illustrating another configuration of a method 600 for connecting to a target device 104 based on an orientation 318 of a Bluetooth device 102. This method 600 may be implemented by the target device 104.

The target device 104 may pair 602 with a Bluetooth device 102. During the pairing, the Bluetooth device 102 and the target device 104 may exchange signals.

The target device 104 may record 604 a reference orientation 318 of the Bluetooth device 102 at the time of pairing. The orientation 318 of the Bluetooth device 102 may be measured as an angle of arrival (AoA) of a signal received from the Bluetooth device 102 at the target device 104.

The target device 104 may receive 606 a connection request from the Bluetooth device 102. For example, in response to a triggering event, the Bluetooth device 102 may send the connection request to the target device 104.

The target device 104 may determine 608 the current orientation 318 of the Bluetooth device 102. If the orientation 318 of the Bluetooth device 102 has changed since pairing with the target device 104, then the current orientation 318 will be different than the reference orientation 318. If the orientation 318 of the Bluetooth device 102 has not changed since pairing with the target device 104, then the current orientation 318 will be the same as the reference orientation 318.

The target device 104 may determine 610 whether the current orientation 318 is within a threshold 112 of the reference orientation 318. In an implementation, the target device 104 may determine 610 whether the difference between the current AoA and the reference AoA is within the threshold 112.

If the current orientation 318 is within a threshold 112 of the reference orientation 318, then the current orientation 318 is considered to match the reference orientation 318 and the target device 104 may connect 612 to the Bluetooth device 102 (or remain connected if currently connected to the Bluetooth device 102). Stated differently, the target device 104 may allow the connection request from the Bluetooth device 102 to proceed.

However, if the target device 104 determines 610 that the current orientation 318 is not within a threshold 112 of the reference orientation 318, then the target device 104 may disconnect 614 from the Bluetooth device 102 (or remain disconnected if not currently connected to the Bluetooth device 102). Stated differently, the target device 104 may deny the connection request from the Bluetooth device 102.

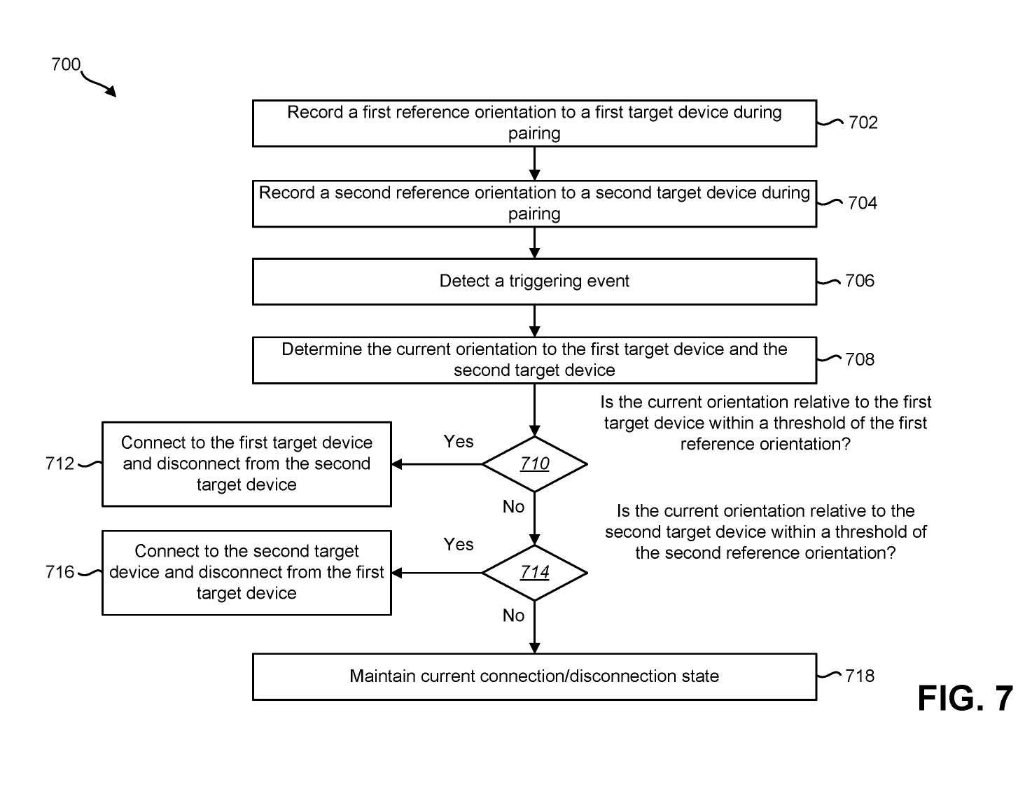

FIG. 7 is a flow diagram illustrating a configuration of a method 700 for connecting to a first target device 104 or a second target device 104 based on an orientation 318 of a Bluetooth device 102. This method 700 may be implemented by the Bluetooth device 102.

The Bluetooth device 102 may record 702 a first reference orientation 318a to the first target device 104 during pairing with the first target device 104. The Bluetooth device 102 may record 704 a second reference orientation 318b to the second target device 104 during pairing with the second target device 104. The orientation 318 of the Bluetooth device 102 may be measured as a signal angle of arrival (AoA) from the Bluetooth device 102 to the target device 104.

In one implementation, the Bluetooth device 102 may receive the first reference orientation 318a from the first target device 104 and the second reference orientation 318b from the second target device 104. The target devices 104 may measure the reference orientation 318. In another implementation, the Bluetooth device 102 may measure the first reference orientation 318a and second reference orientation 318b itself.

The Bluetooth device 102 may detect 708 a triggering event. For example, the Bluetooth device 102 may detect 706 that a key was pressed on the Bluetooth device 102.

The Bluetooth device 102 may determine 708 the current orientation 318 to the first target device 104 and the second target device 104. As with the reference orientation 318, the Bluetooth device 102 may receive the current orientations 318 from the target devices 104 or the Bluetooth device 102 may measure the current orientations 318 itself.

If the Bluetooth device 102 determines 710 that the current orientation 318 relative to the first target device 104 is within a threshold 112 of the first reference orientation 318a, then the Bluetooth device 102 may connect 712 (or remain connected) to the first target device 104. The Bluetooth device 102 may also disconnect from the second target device 104.

If the current orientation 318 relative to the first target device 104 is not within a threshold 112 of the first reference orientation 318a, then the Bluetooth device 102 may determine 714 whether the current orientation 318 relative to the second target device 104 is within a threshold 112 of the second reference orientation 318b. If this is the case, the Bluetooth device 102 may connect 716 (or remain connected) to the second target device 104. The Bluetooth device 102 may also disconnect from the first target device 104.

If the Bluetooth device 102 determines 714 that the current orientation 318 relative to the second target device 104 is not within a threshold 112 of the first reference orientation 318a, then the Bluetooth device 102 may maintain 718 the current connection/disconnection state between the first target device 104 and the second target device 104. In this case, the current orientation 318 is not sufficiently clear to make a connection or disconnection determination.

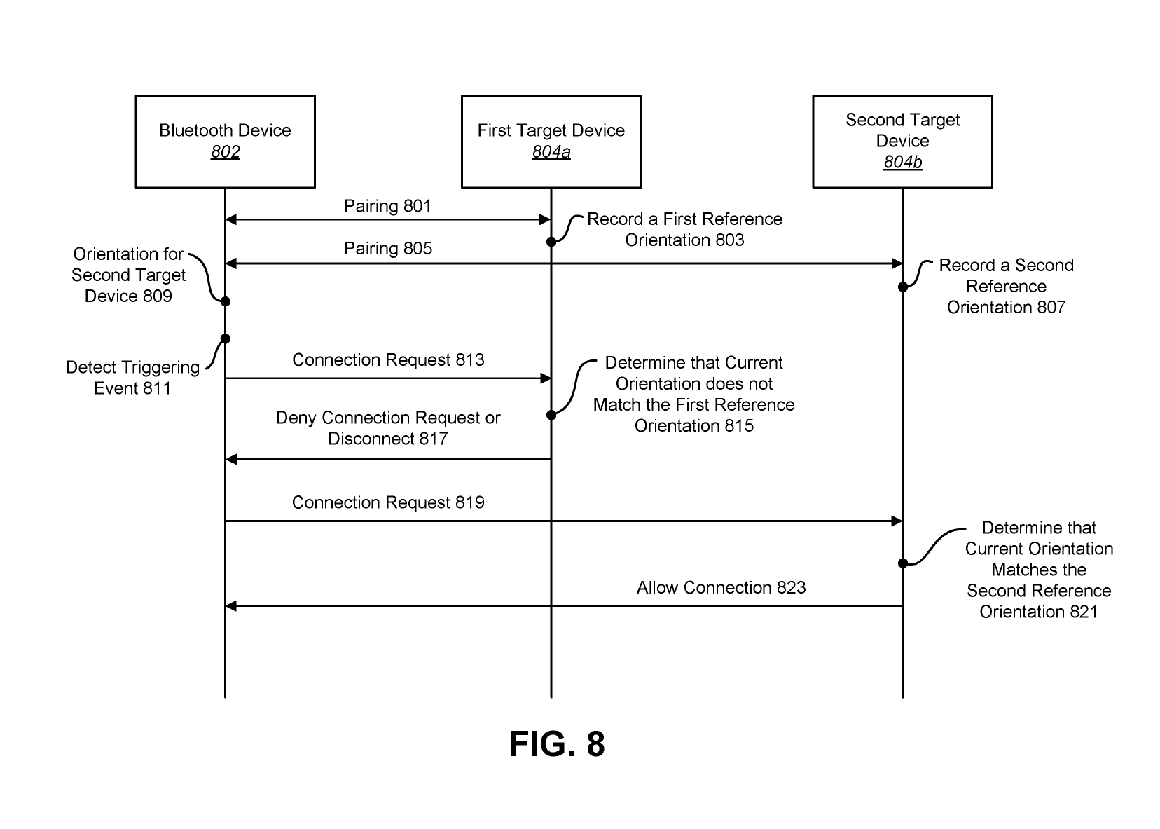

FIG. 8 is a sequence diagram illustrating position-based connection of a Bluetooth device 802 to a first target device 804a or a second target device 804b. The Bluetooth device 802 may pair 801 with the first target device 804a. During pairing, the first target device 804a may record 803 a first reference orientation 318a of the Bluetooth device 802 relative to the first target device 804a.

The Bluetooth device 802 may pair 805 with the second target device 804b. During pairing, the second target device 804b may record 807 a second reference orientation 318b of the Bluetooth device 802 relative to the second target device 804b.

The Bluetooth device 802 may be oriented 809 for the second target device 804b. For example, after pairing 805 with the second target device 804b, the Bluetooth device 802 may remain in the same orientation 318 that was used during pairing 805. Alternatively, the orientation 318 of the Bluetooth device 802 may change, but at some point the Bluetooth device 802 may again be oriented 809 with the same orientation 318 that was used during pairing 805.

The Bluetooth device 802 may detect 811 a triggering event. For example, the Bluetooth device 102 may detect 811 that a key was pressed on the Bluetooth device 102.

The Bluetooth device 802 may send 813 a connection request to the first target device 804a. Upon receiving the connection request, the first target device 804a may determine 815 that the current orientation 318 of the Bluetooth device 802 relative to the first target device 804a does not match the first reference orientation 318a. The first target device 804a may deny 817 the connection request. If the Bluetooth device 802 is currently connected to the first target device 804a, the first target device 804a may disconnect from the Bluetooth device 802.

The Bluetooth device 802 may send 819 a connection request to the second target device 804b. Upon receiving the connection request, the second target device 804b may determine 821 that the current orientation 318 of the Bluetooth device 802 relative to the second target device 804b matches the second reference orientation 318b. The second target device 804b may allow 823 the connection request. If the Bluetooth device 802 is currently connected to the first target device 804a, the second target device 804b may maintain the connection to the Bluetooth device 802.

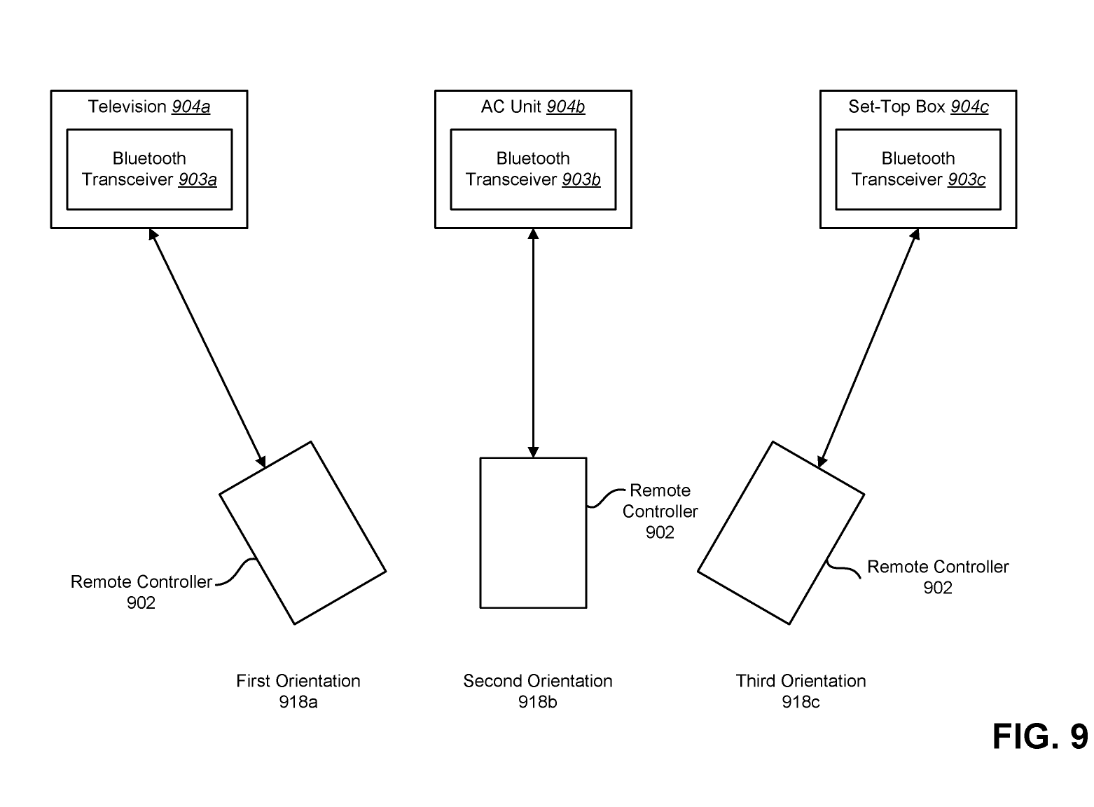

FIG. 9 is an example of orientation-based connection by a remote controller 902 to a television 904a, an air conditioning (AC) unit 904b or a set-top box 904c. The remote controller 902 may be implemented in accordance with the Bluetooth device 102 described in connection with FIG. 1. The television 904a, AC unit 904b and set-top box 904c may be implemented in accordance with the target device 104 described in connection with FIG. 1. For example, each of the television 904a, AC unit 904b and set-top box 904c may include a Bluetooth transceiver 903a-c.

The remote controller 902 may pair with the television 904a with a first orientation 918a. The remote controller 902, television 904a or both may record the first orientation 918a as a first reference orientation. In an implementation, the remote controller 902 may be pointed at the television 904a. However, any orientation of the remote controller 902 may be used.

The remote controller 902 may pair with the AC unit 904b with a second orientation 918b. The remote controller 902, AC unit 904b or both may record the second orientation 918b as a second reference orientation. In an implementation, the remote controller 902 may be pointed at the AC unit 904b or an orientation other than the first orientation 918a.

The remote controller 902 may pair with the set-top box 904c with a third orientation 918c. The remote controller 902, set-top box 904c or both may record the third orientation 918c as a third reference orientation. In an implementation, the remote controller 902 may be pointed at the set-top box 904c or an orientation other than the first orientation 918a or second orientation 918b.

In one scenario, the user of the remote controller 902 may wish to connect to the television 904a. The user may orient the remote controller 902 with the first orientation 918a. Upon performing a keypress on the remote controller 902, the remote controller 902 may try to connect to each device, one after the other. The target devices 904 would allow connection based on the current orientation of the remote controller 902. In this scenario, the television 904a will connect to the remote controller 902 as the current orientation matches the reference orientation of the television 904a. A similar procedure may be implemented to connect to the AC unit 904b using the second orientation 918b and the set-top box 904c using the third orientation 918c.

As observed in this discussion, a single remote controller 902 may be seamlessly used for multiple target devices 904. The remote controller 902 automatically connects to the desired target device 904 based on the user intention.

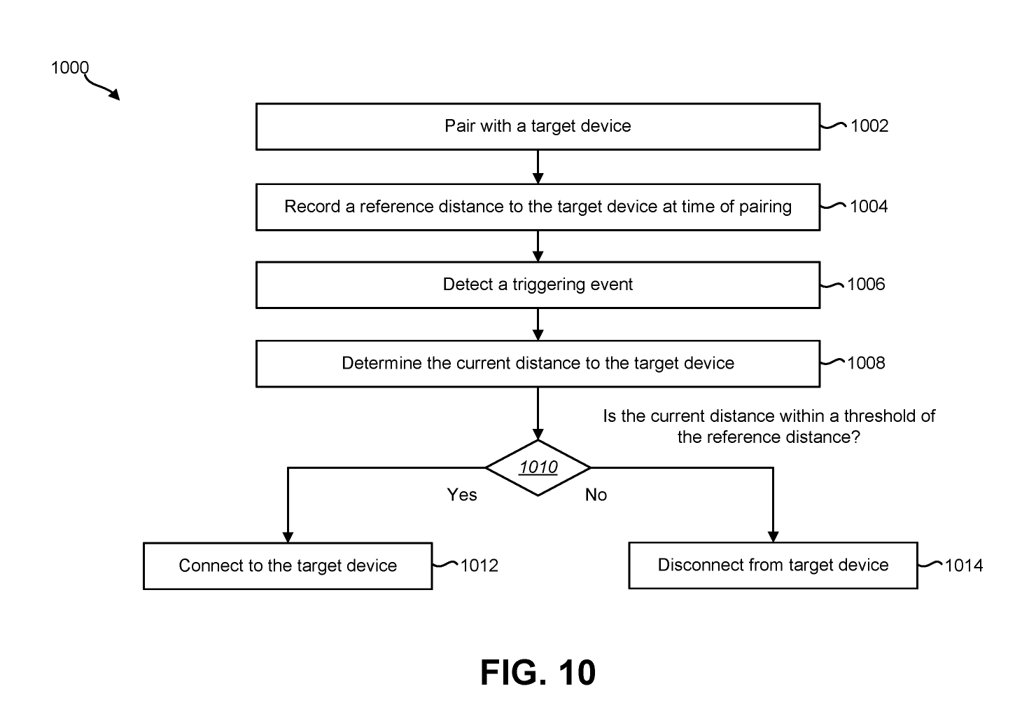

FIG. 10 is a flow diagram illustrating a configuration of a method 1000 for connecting to a target device 104 based on a relative distance 422. This method 1000 may be implemented by the Bluetooth device 102.

The Bluetooth device 102 may pair 1002 with a target device 104. During the pairing, the Bluetooth device 102 and the target device 104 may exchange signals. The Bluetooth device 102 may record 1004 a reference distance 422 to the target device 104 at the time of pairing.

The Bluetooth device 102 may detect 1006 a triggering event. For example, the Bluetooth device 102 may detect 1006 that a key was pressed on the Bluetooth device 102.

The Bluetooth device 102 may determine 1008 the current distance 422 to the target device 104. The Bluetooth device 102 may determine 1010 whether the current distance 422 is within a threshold 112 of the reference distance 422. If the current distance 422 is within a threshold 112 of the reference distance 422, then the Bluetooth device 102 may connect 1012 to the target device 104 (or remain connected if currently connected to the target device 104). However, if the Bluetooth device 102 determines 1010 that the current distance 422 is not within a threshold 112 of the reference distance 422, then the Bluetooth device 102 may disconnect 1014 from the target device 104 (or remain disconnected if not currently connected to the target device 104).

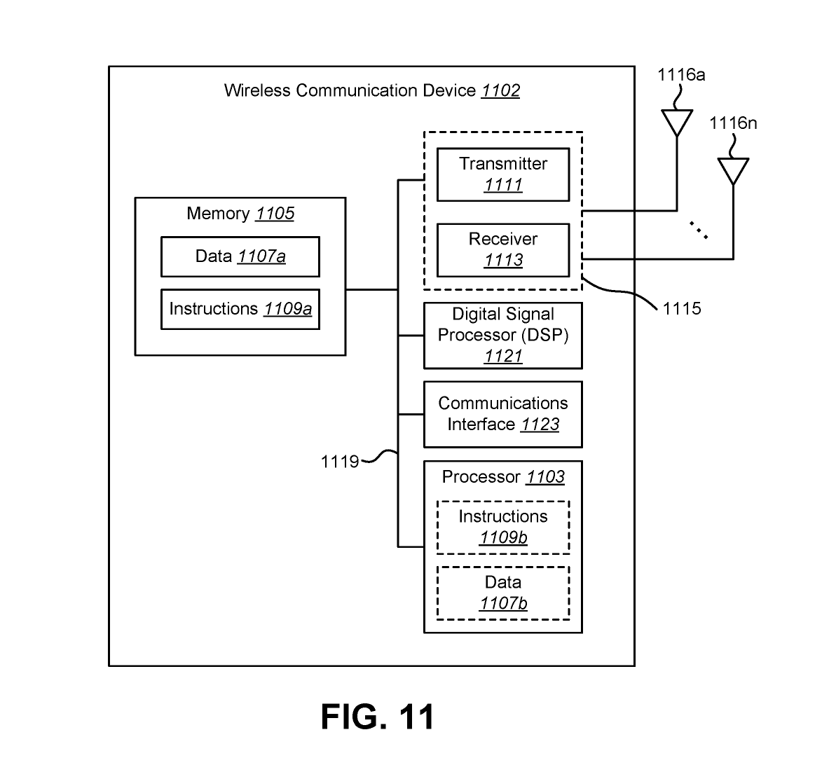

FIG. 11 illustrates certain components that may be included within a wireless communication device 1102. The wireless communication device 1102 may be a wireless device, an access terminal, a mobile station, a user equipment (UE), a laptop computer, a desktop computer, a wireless headset, keyboard, keypad, computer mouse, remote controllers, etc. For example, the wireless communication device 1102 may be a Bluetooth device 102 or a target device 104 of FIG. 1.

The wireless communication device 1102 includes a processor 1103. The processor 1103 may be a general purpose single- or multi-chip microprocessor (e.g., an Advanced RISC (Reduced Instruction Set Computer) Machine (ARM)), a special purpose microprocessor (e.g., a digital signal processor (DSP)), a microcontroller, a programmable gate array, etc. The processor 1103 may be referred to as a central processing unit (CPU). Although just a single processor 1103 is shown in the wireless communication device 1102 of FIG. 11, in an alternative configuration, a combination of processors (e.g., an ARM and DSP) could be used.

The wireless communication device 1102 also includes memory 1105 in electronic communication with the processor (i.e., the processor can read information from and/or write information to the memory). The memory 1105 may be any electronic component capable of storing electronic information. The memory 1105 may be configured as random access memory (RAM), read-only memory (ROM), magnetic disk storage media, optical storage media, flash memory devices in RAM, on-board memory included with the processor, erasable programmable read-only memory (EPROM), electrically erasable programmable read-only memory (EEPROM), registers and so forth, including combinations thereof.

Data 1107a and instructions 1109a may be stored in the memory 1105. The instructions may include one or more programs, routines, sub-routines, functions, procedures, code, etc. The instructions may include a single computer-readable statement or many computer-readable statements. The instructions 1109a may be executable by the processor 1103 to implement the methods disclosed herein. Executing the instructions 1109a may involve the use of the data 1107a that is stored in the memory 1105. When the processor 1103 executes the instructions 1109, various portions of the instructions 1109b may be loaded onto the processor 1103, and various pieces of data 1107b may be loaded onto the processor 1103.

The wireless communication device 1102 may also include a transmitter 1111 and a receiver 1113 to allow transmission and reception of signals to and from the wireless communication device 1102 via a one or more antennas 1116a-n. The transmitter 1111 and receiver 1113 may be collectively referred to as a transceiver 1115. The wireless communication device 1102 may also include (not shown) multiple transmitters, multiple antennas, multiple receivers and/or multiple transceivers.

The wireless communication device 1102 may include a digital signal processor (DSP) 1121. The wireless communication device 1102 may also include a communications interface 1123. The communications interface 1123 may allow a user to interact with the wireless communication device 1102.

The various components of the wireless communication device 1102 may be coupled together by one or more buses, which may include a power bus, a control signal bus, a status signal bus, a data bus, etc. For the sake of clarity, the various buses are illustrated in FIG. 11 as a bus system 1119.

In the above description, reference numbers have sometimes been used in connection with various terms. Where a term is used in connection with a reference number, this may be meant to refer to a specific element that is shown in one or more of the Figures. Where a term is used without a reference number, this may be meant to refer generally to the term without limitation to any particular Figure.

The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The phrase “based on” does not mean “based only on,” unless expressly specified otherwise. In other words, the phrase “based on” describes both “based only on” and “based at least on.”

The term “processor” should be interpreted broadly to encompass a general purpose processor, a central processing unit (CPU), a microprocessor, a digital signal processor (DSP), a controller, a microcontroller, a state machine, and so forth. Under some circumstances, a “processor” may refer to an application specific integrated circuit (ASIC), a programmable logic device (PLD), a field programmable gate array (FPGA), etc. The term “processor” may refer to a combination of processing devices, e.g., a combination of a digital signal processor (DSP) and a microprocessor, a plurality of microprocessors, one or more microprocessors in conjunction with a digital signal processor (DSP) core, or any other such configuration.

The term “memory” should be interpreted broadly to encompass any electronic component capable of storing electronic information. The term memory may refer to various types of processor-readable media such as random access memory (RAM), read-only memory (ROM), non-volatile random access memory (NVRAM), programmable read-only memory (PROM), erasable programmable read-only memory (EPROM), electrically erasable PROM (EEPROM), flash memory, magnetic or optical data storage, registers, etc. Memory is said to be in electronic communication with a processor if the processor can read information from and/or write information to the memory. Memory that is integral to a processor is in electronic communication with the processor.

The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may comprise a single computer-readable statement or many computer-readable statements.

The functions described herein may be implemented in software or firmware being executed by hardware. The functions may be stored as one or more instructions on a computer-readable medium. The terms “computer-readable medium” or “computer-program product” refers to any tangible storage medium that can be accessed by a computer or a processor. By way of example, and not limitation, a computer-readable medium may include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and Blu-ray® disc where disks usually reproduce data magnetically, while discs reproduce data optically with lasers. It should be noted that a computer-readable medium may be tangible and non-transitory. The term “computer-program product” refers to a computing device or processor in combination with code or instructions (e.g., a “program”) that may be executed, processed or computed by the computing device or processor. As used herein, the term “code” may refer to software, instructions, code or data that is/are executable by a computing device or processor.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

The methods disclosed herein comprise one or more steps or actions for achieving the described method. The method steps and/or actions may be interchanged with one another without departing from the scope of the claims. In other words, unless a specific order of steps or actions is required for proper operation of the method that is being described, the order and/or use of specific steps and/or actions may be modified without departing from the scope of the claims.

Further, it should be appreciated that modules and/or other appropriate means for performing the methods and techniques described herein, such as illustrated by FIG. 2, FIGS. 5-7 and FIG. 10, can be downloaded and/or otherwise obtained by a device. For example, a device may be coupled to a server to facilitate the transfer of means for performing the methods described herein. Alternatively, various methods described herein can be provided via a storage means (e.g., random access memory (RAM), read only memory (ROM), a physical storage medium such as a compact disc (CD) or floppy disk, etc.), such that a device may obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the systems, methods, and apparatus described herein without departing from the scope of the claims.

What is claimed is:

1. A method for connecting to a target device by a Bluetooth device based on a position metric, comprising:
measuring a reference position metric between the Bluetooth device and the target device during pairing of the Bluetooth device with the target device;
detecting a current position metric between the Bluetooth device and the target device; and
connecting to the target device based on a comparison of the current position metric and the reference position metric that was measured while previously pairing the Bluetooth device with the target device.

2. The method of claim 1, wherein the Bluetooth device connects to the target device if the current position metric is within a certain threshold of the reference position metric.

3. The method of claim 1, further comprising disconnecting from the target device if the current position metric is not within a certain threshold of the reference position metric.

4. The method of claim 1, wherein the position metric is an orientation of the Bluetooth device relative to the target device.

5. The method of claim 4, wherein the orientation is measured as a signal angle of arrival (AoA) from the Bluetooth device to the target device.

6. The method of claim 1, further comprising receiving the reference position metric and the current position metric from the target device.

7. The method of claim 1, wherein the Bluetooth device measures the reference position metric and the current position metric.

8. The method of claim 1, wherein the position metric is a relative distance between the Bluetooth device and the target device.

9. The method of claim 8, wherein the Bluetooth device connects to a first target device upon determining that the first target device is closer than a second target device.

10. The method of claim 1, wherein the current position metric is detected in response to a triggering event.

11. The method of claim 1, further comprising:
attempting, by the Bluetooth device, to connect to a plurality of target devices in response to a triggering event; and
connecting to a given target device with a reference position metric that matches the current position metric of the Bluetooth device.

12. A Bluetooth device configured to connect to a target device based on a position metric, comprising:
a processor;
a memory in communication with the processor; and
instructions stored in the memory, the instructions executable by the processor to:
measure a reference position metric between the Bluetooth device and the target device during pairing of the Bluetooth device with the target device;
detect a current position metric between the Bluetooth device and the target device; and
connect to the target device based on a comparison of the current position metric and the reference position metric that was measured while previously pairing the Bluetooth device with the target device.

13. The Bluetooth device of claim 12, wherein the Bluetooth device connects to the target device if the current position metric is within a certain threshold of the reference position metric.

14. The Bluetooth device of claim 12, further comprising instructions executable to disconnect from the target device if the current position metric is not within a certain threshold of the reference position metric.

15. The Bluetooth device of claim 12, wherein the position metric is an orientation of the Bluetooth device relative to the target device.

16. The Bluetooth device of claim 12, wherein the position metric is a relative distance between the Bluetooth device and the target device.

17. The Bluetooth device of claim 16, wherein the Bluetooth device connects to a first target device upon determining that the first target device is closer than a second target device.

18. The Bluetooth device of claim 12, further comprising instructions executable to:
attempt, by the Bluetooth device, to connect to a plurality of target devices in response to a triggering event; and
connect to a given target device with a reference position metric that matches the current position metric of the Bluetooth device.

19. A method for connecting to a Bluetooth device by a target device based on a position metric, comprising:
measuring a reference position metric between the Bluetooth device and the target device during pairing of the Bluetooth device with the target device;
detecting a current position metric between the Bluetooth device and the target device; and
connecting to the Bluetooth device based on a comparison of the current position metric and the reference position metric that was measured while previously pairing the Bluetooth device with the target device.

20. The method of claim 19, wherein the target device connects to the Bluetooth device if the current position metric is within a certain threshold of the reference position metric.

21. The method of claim 19, further comprising disconnecting from the Bluetooth device if the current position metric is not within a certain threshold of the reference position metric.

22. The method of claim 19, wherein the position metric is an orientation of the Bluetooth device relative to the target device.

23. The method of claim 22, wherein the orientation is measured as a signal angle of arrival (AoA) from the Bluetooth device to the target device.

24. The method of claim 19, wherein the target device measures the reference position metric and the current position metric.

25. The method of claim 19, wherein the position metric is a relative distance between the Bluetooth device and the target device.

26. A target device configured to connect to a Bluetooth device based on a position metric, comprising:
a processor;
a memory in communication with the processor; and
instructions stored in the memory, the instructions executable by the processor to:
measure a reference position metric between the Bluetooth device and the target device during pairing of the Bluetooth device with the target device;
detect a current position metric between the Bluetooth device and the target device; and
connect to the Bluetooth device based on a comparison of the current position metric and the reference position metric that was measured while previously pairing the Bluetooth device with the target device.

27. The target device of claim 26, wherein the target device connects to the Bluetooth device if the current position metric is within a certain threshold of the reference position metric.

28. The target device of claim 26, further comprising instructions executable to disconnect from the Bluetooth device if the current position metric is not within a certain threshold of the reference position metric.

29. The target device of claim 26, wherein the position metric is an orientation of the Bluetooth device relative to the target device.

30. The target device of claim 26, wherein the position metric is a relative distance between the Bluetooth device and the target device.
